(19) United States
(12) Patent Application Publication
(10) Pub. No.: US 2009/0101857 A1
(43) Pub. Date: Apr. 23, 2009

(54) VALVE ASSEMBLY

(75) Inventors: Ian Wilson, Lancashire (GB); David Bailey, Lancashire (GB)

Correspondence Address: BROOKS KUSHMAN P.C., 1000 TOWN CENTER, TWENTY-SECOND FLOOR, SOUTHFIELD, MI, 48075, US

(73) Assignee: FORT VALE ENGINEERING LIMITED, Lancashire (GB)

(21) Appl. No.: 12/158,799

(22) PCT Filed: Dec. 11, 2006
(86) PCT No.: PCT/EP06/69563

§ 371 Date: Nov. 28, 2008

(30) Foreign Application Priority Data
Dec. 24, 2005 (GB) 0526374.4

(51) Int. Cl. F16K 27/07

(52) U.S. Cl. 251/208; 251/357; 251/360; 251/305; 251/229

(57) ABSTRACT

A valve assembly has a valve housing, an inlet, an outlet and a flow passage extending between the inlet and the outlet. A shut-off valve is mounted on the housing adjacent the inlet and a flow control valve is mounted on the housing adjacent the outlet. By mounting both valves on the same housing, the dimensions of the assembly are reduced.

The present invention relates to valve assemblies and in particular, but not exclusively, to valve assemblies for use with ISO tank containers.

ISO tank containers are vessels which are used for the transport of liquids and gases in bulk. The fluid container itself is usually a cylindrical tank which fits within a cuboidal supporting framework of standard dimensions and having standard connecting sockets at its corners, so that the unit can be manoeuvred, secured and transported using standardised equipment.

One of the safety requirements of ISO tank containers is that the tank outlet must be provided with two valves, a first control valve for controlling the flow of fluid from the tank and a second shut-off valve which can be closed very rapidly in the event of an emergency or malfunction. It is the practice to connect the shut-off valve to the tank outlet and then to connect the control valve to the outlet of the shut-off valve. While this gives a very satisfactory performance and satisfies safety requirements, the size of the two valves in combination is fairly large. As a consequence, the space available for the tank within the confines of a standard ISO tank container framework is reduced, thereby reducing the maximum volume of tank which can fit within the framework.

It is an aim of the present invention to reduce the amount of space occupied by the two valves, so that the maximum volume available for a tank within the confines of an ISO tank container framework is increased.

In accordance with a first aspect of the present invention, a valve assembly comprises a valve housing having an inlet, an outlet and a flow passage extending between the inlet and the outlet, and first and second valves mounted on the valve housing for controlling the flow of fluid through the flow passage.

By mounting both valves on a common valve housing, less space is used as compared with two separate valves. As a consequence, more space is available within the confines of an ISO tank container framework, which allows tanks of larger volume to be transported.

In one embodiment, one of the first and second valves comprises a valve closure member mounted on the valve housing and releasably engageable with a valve seat, the valve seat being formed on the valve housing.

One of the first and second valves may comprise a valve closure member mounted on the valve housing and releasably engageable with a seat which is formed separately from the valve housing, the assembly further comprising means for attaching the valve seat to the valve housing.

In accordance with a second aspect of the present invention, a valve assembly comprises a valve housing having an inlet, an outlet and a flow passage extending between the inlet and the outlet, and first and second valves for controlling the flow of fluid through the flow passage, each of the first and second valves comprising a valve closure member engageable with a valve seat, the valve closure members being mounted on the valve housing.

One of the first and second valves may comprise a valve seat formed on the valve housing.

One of the first and second valves may comprise a valve seat formed separately from the valve housing, the assembly further comprising means for attaching the valve seat to the valve housing.

For both aspects of the present invention, one of the first and second valves is preferably located adjacent to the inlet.

One of the first and second valves is preferably located adjacent to the outlet.

Preferably, one of the first and second valves comprises a shut-off valve.

Preferably, one of the first and second valves comprises a regulating valve, e.g. a butterfly valve.

In one embodiment, the valve closure member of the butterfly valve is angularly displaceable through an obtuse angle. Preferably, the valve closure member is displaceable through an angle whereby the normally innermost face of the valve closure member faces downstream. In one embodiment, the valve closure member is displaceable through an angle of approximately 160°.

By enabling the valve closure to be displaceable through an obtuse angle, greater access is provided to the valve closure member on its upstream side, which allows easiest and more thorough cleaning of the valve components. This is particularly important if the tank to which the valve assembly is connected is to transport different materials.

Preferably, the valve assembly further comprises means for temporarily securing the regulating valve in a predetermined position, and more preferably in one of a plurality of predetermined positions. Preferably, the flow passage is elongated and more preferably the cross-sectional area of the flow passage is larger at the outlet than at the inlet.

The assembly also preferably comprises connection means for connecting the valve housing to the outlet of a source of fluid whose flow is to be controlled. The connection means may comprise a connection flange.

By way of example only, specific embodiments of the present invention will now be described, with reference to the accompanying drawings, in which:

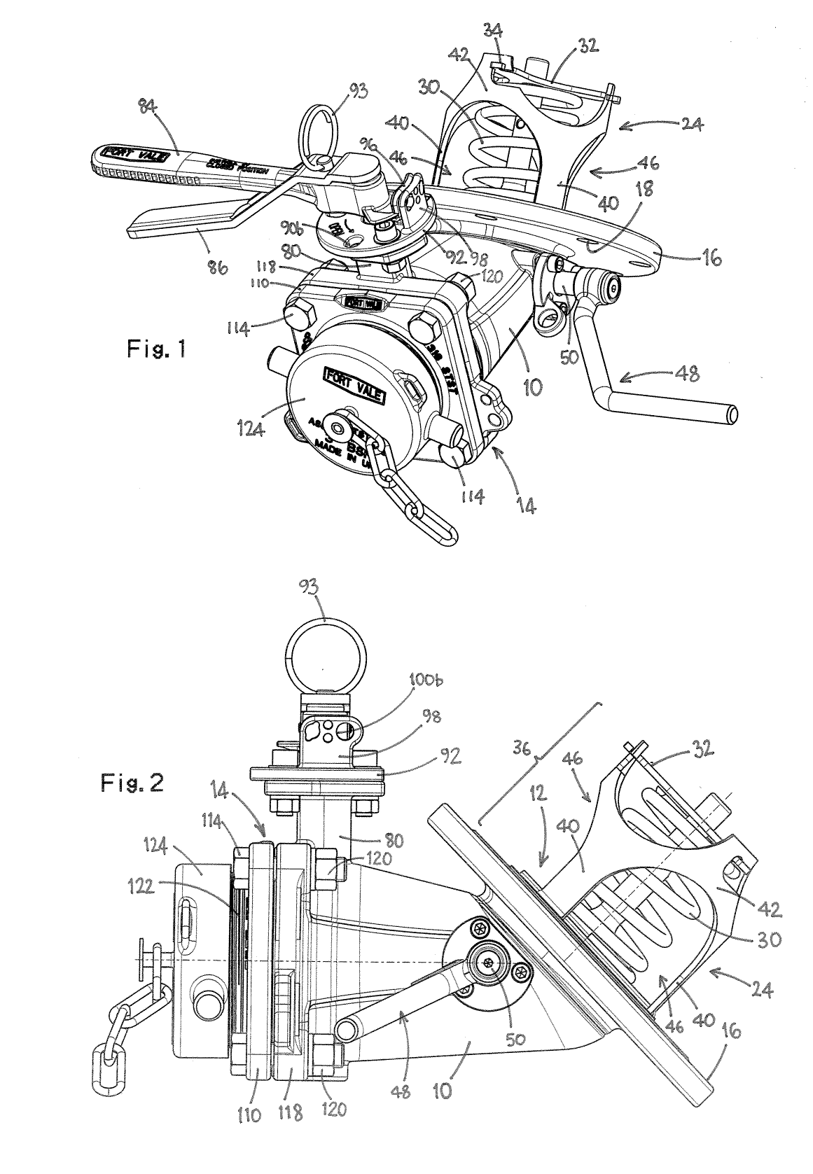

FIG. 1 is a perspective view of an embodiment of valve assembly in accordance with the present invention;

FIG. 2 is a side view of the valve assembly of FIG. 1;

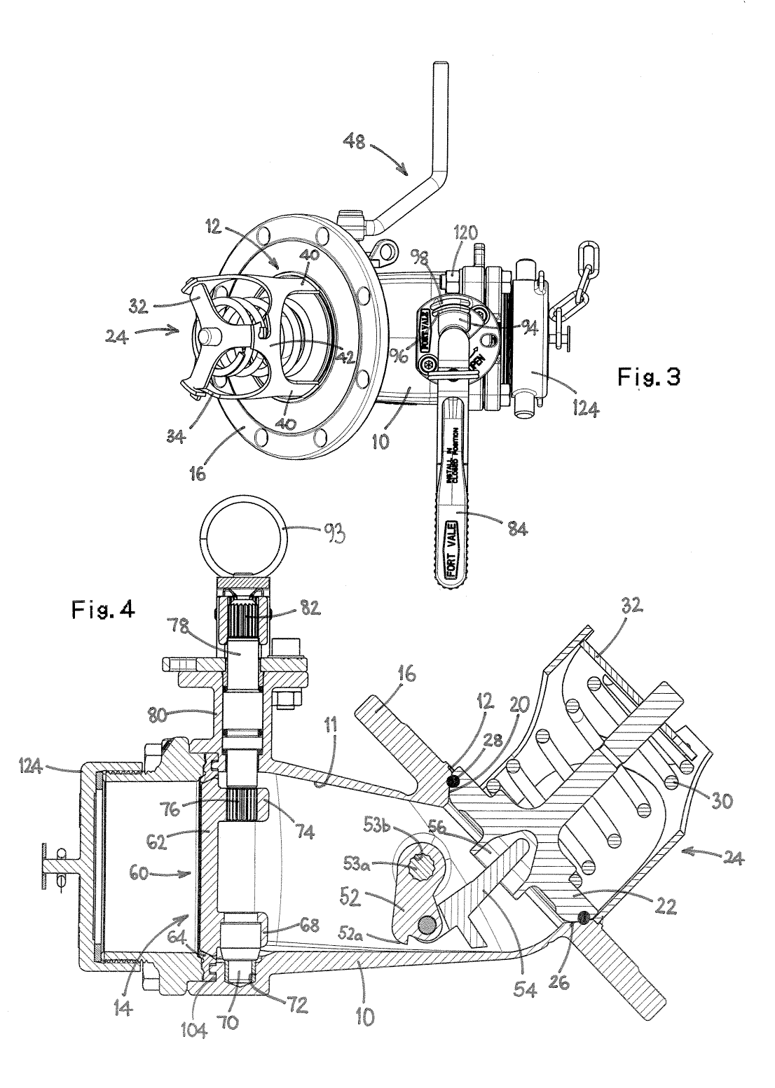

FIG. 3 is a plan view of the valve assembly of FIG. 1;

FIG. 4 is a longitudinal cross-section through the valve assembly of FIG. 1;

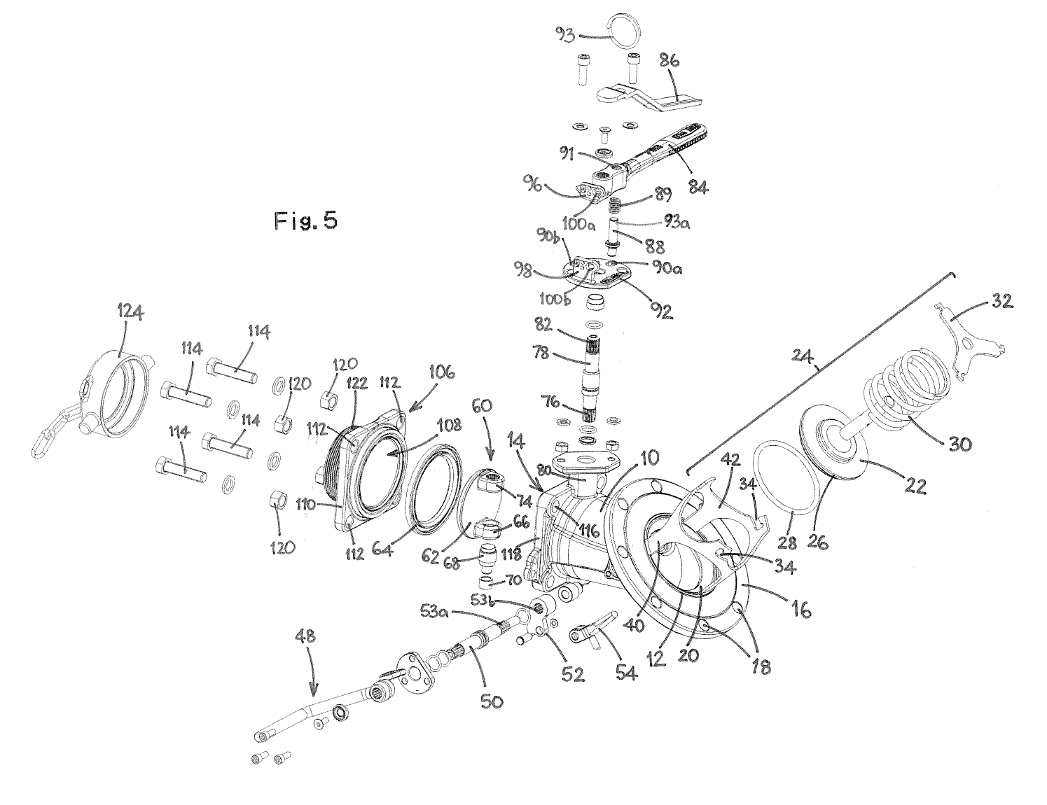

FIG. 5 is an exploded perspective view of the valve assembly of FIG. 1;

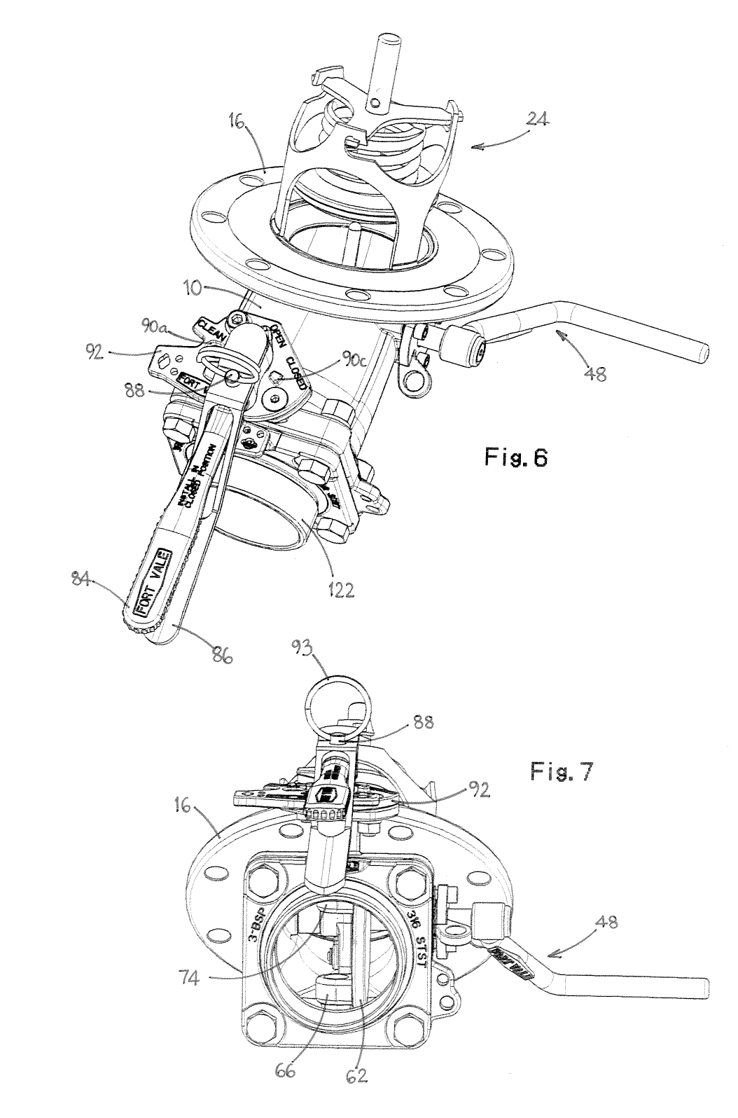

FIG. 6 is a perspective view from above of a second embodiment of valve assembly in accordance with the present invention, shown in an open condition;

FIG. 7 is an end view of the valve of FIG. 6;

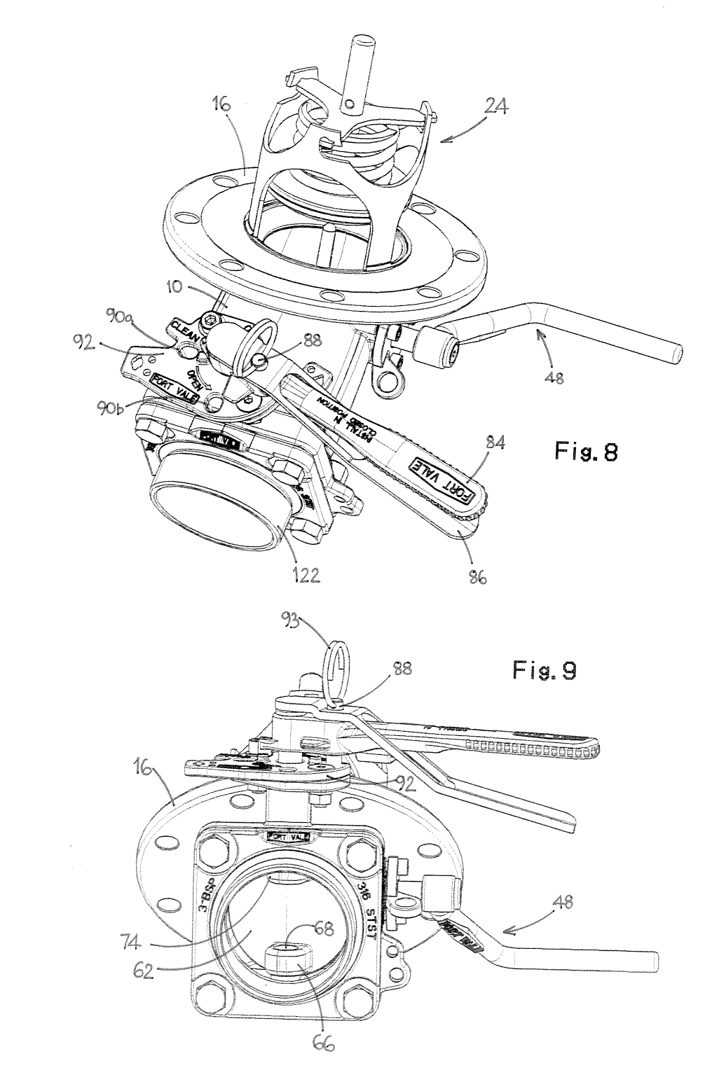

FIG. 8 is a perspective view from above of the valve of FIG. 6, shown in a cleaning condition; and

FIG. 9 is an end view of the valve of FIG. 8.

The accompanying drawings illustrate valve assemblies which are particularly suitable for connection to the outlet port of an ISO container tank for discharging liquid and gaseous products from the container.

The valve assembly shown in FIGS. 1 to 5 comprises an elongate main valve housing 10 which has an elongate flow passage 11 which increases in cross-sectional area from an inlet end 12 to an outlet end 14. The inlet end 12 is provided with an annular mounting flange 16 having eight equally angularly spaced apertures 18, by means of which the valve assembly is secured to a corresponding mounting flange (not shown) around the discharge port of an ISO tank container. As illustrated in the drawings, the mounting flange 16 is inclined to the longitudinal axis of the main valve housing 10 to fit the flange on the ISO tank container.

Radially inwardly of the mounting flange 16, the main valve housing 10 is formed into a frusto-conical valve seat 20 which is sealingly engageable with a first valve closure member 22 which forms part of a shut-off valve 24 mounted on the valve housing adjacent the inlet 12. The valve closure member 22 comprises a circular disc having a frusto-conical face 26 adapted to engage the frusto-conical valve seat 20 of the valve housing. The frusto-conical face 26 of the valve closure member also carries an annular elastomeric seal 28.

The valve closure member 22 is biased towards sealing engagement with the frusto-conical valve seat 20 by means of a strong compression spring 30. One end of the compression spring 30 abuts the rear face of the valve closure member 22 and the opposite end of the spring abuts a three-legged spring abutment plate 32. The legs of the abutment plate 32 engage respective recesses 34 in the upper end of a bayonet cap 36 which is welded to, and extends away from, the main valve housing 10. The bayonet cap 36 comprises three equally-angularly spaced legs 40 extending perpendicularly from the inlet end 12 of the housing between the attachment flange 16 and the valve seat 20, the adjacent legs 40 being interconnected by cross-pieces 42 in which the securing recesses 34 for the spring abutment plate 32 are formed. The legs 40 and cross-pieces 42 define apertures 46 through which fluid may flow into the valve housing 10.

The first valve closure member 22 may be displaced from its closed position by displacing it from the valve seat 20 against the restoring force of the spring 30. This is achieved by means of a manually-operated handle 48 which is connected to a pivotally-mounted shaft 50 which passes sealingly through, and is mounted in diametrically opposed portions of, the main valve housing 10.

The shaft 50 receives a cam member 52 by means of splined connection 53a, 53b on the shaft and cam. The cam member 52 is pivotally connected to a valve actuating finger 54 located within the valve housing 10. The opposite end of the valve actuating finger 54 is received in a generally conical recess 56 in the opposing face of the first valve closure member 22. Thus, by pivoting of the handle 48 (in an anti-clockwise direction as shown in FIG. 2), the first valve closure member 22 may be lifted from engagement with the valve seat 20 into an open position. The cam member 52 rotates onto an integral stop 52a in an over-centre motion and thereby holds the valve 24 in the open position until the handle 48 is pivoted in the opposite direction.

A flow control valve in the form of a butterfly valve, indicated generally at 60, is also mounted on the main valve housing 10 adjacent the outlet 14. The butterfly valve 60 comprises a circular disc-shaped valve closure member 62 engageable with an annular valve seat 64. The upstream side of the valve closure member 62 of the butterfly valve is provided with a first mounting lug 66 which receives a stub shaft 68 which is pivotally received in a bearing 70 located in a recess 72 of the main valve housing 10. A second lug 74 on the upstream side of the valve closure member is internally splined and receives a splined end connection 76 of an actuating shaft 78 which passes sealingly through a tubular extension 80 of the main valve housing 10 which extends perpendicularly to the longitudinal direction of the main valve housing 10. The outer end of the actuating shaft 78 is also provided with a splined portion 82 by means of which it is connected to an actuating handle 84 which extends perpendicularly to the actuating shaft 78. The handle 84 also carries an operating lever 86. The lever 86 is pivotally mounted on the handle 84 and by squeezing the lever with respect to the handle, the lever lifts a handle locating pin 88 which is receivable in one of two recesses 90a, 90b in a circular locating flange 92 extending perpendicularly to the tubular extension 80, by means of which the handle and the valve closure member 62 of the butterfly valve 60 may be retained in a desired one of two extreme positions, open and closed, at right angles to each other. The pin 88 is biassed towards the locating flange 92 and the recesses 90a, 90b therein (downwards as seen in FIG. 5) by means of a compression spring 89. The pin projects through a hole 91 in the handle and may alternatively be withdrawn from the recesses 90a, 90b by means of a ring 93 which passes through a diametrically extending hole 93a in the upper end of the pin 88.

A flat lug 94 projects from the portion of the handle adjacent to the actuating shaft 78 and an arcuate planar security lug 96 projects perpendicularly from the lug 94. A second arcuate planar security lug 98 projects perpendicularly from the circular locating flange 92. The lugs are positioned adjacent to each other when the valve closure member 62 is in a closed position, which allows a security seal (not shown) to be passed through aligned apertures 100a, 100b in the lugs 96, 98.

The valve closure member 62 of the butterfly valve is engageable with the annular valve seat member 64. The annular valve seat member 64 is received in a complimentarily-shaped annular recess 104 at the outlet end of the main valve housing 10 and is retained in position by means of a retaining coupling 106 having a central circular aperture 108 which corresponds to the aperture of the valve seat member 64 and having a peripheral flange 110 with four bolt-receiving apertures 112 for receipt of retaining bolts 114 which pass through the apertures into corresponding apertures 116 in a retaining flange 118 at the outlet end 14 of the main valve housing 10 and which are retained by means of nuts 120. The outer end of the retaining coupling 106 is also provided with an externally-threaded tubular neck portion 122 which is adapted to screw-threadedly receive an internally threaded end cap 124 which closes off the valve assembly from the exterior when it is not in use.

In use, the end cap 124 is firstly unscrewed. The butterfly valve 60 is then opened by squeezing the operating lever 86, which causes the spring-loaded locating pin 88 to be withdrawn from its associated aperture 90a, 90b. The handle 84 of the butterfly valve 60 can then be pivoted through a right angle in order to open the butterfly valve. The lever is released, which allows the spring-loaded locating pin 88 to engage in the other aperture 90b, thereby retaining the butterfly valve 60 in the open position.

When the butterfly valve 68 is opened, the shut-off valve 24 is then opened by rotating the handle 48 of the valve anti-clockwise (as illustrated in FIG. 2), which causes the actuating finger 54 to engage with the recess 56 in the downstream face of the valve closure member 22 and thereby lift the valve closure member 22 from its seat 20, in which position it is held by engagement of the integral stop 52a of the cam member 52. Fluid is then allowed to pass firstly through the shut-off valve 24, and thence through the butterfly valve 60 and out of the valve assembly.

When it is desired to stop the flow of fluid, the shut-off valve 24 is firstly closed by rotating the handle 48 of the valve in the clockwise direction (as illustrated in FIG. 2). The biasing of the spring 30 of the shut-off valve ensures that the shut-off 20o valve closes very quickly. When the flow of fluid through the main valve housing 10 has ceased, the butterfly valve 60 is then closed by squeezing the operating lever 86, which withdraws the spring-loaded retaining pin 88 from its associated aperture 90b, and pivoting the handle 84 through a right angle so that the butterfly valve closure member 62 assumes a closed position with respect to the valve seat member. The lever 86 is then released, which allows the spring-loaded retaining pin 88 to engage the first recess 90a, thereby securing the butterfly valve in its closed position. If the valve assembly is not to be used for some time thereafter, the end cap 124 is then screwed onto the externally-threaded tubular neck portion 122.

A second embodiment of the present invention is illustrated in FIGS. 6 to 9. The second embodiment is very similar to the first embodiment and its construction and operation are identical to that of the first embodiment, except as described below.

The main difference between the second embodiment and the first embodiment is that, whereas the butterfly valve 60 is movable through a maximum range of 90° between a first, closed position, and a second, opened position, in the second embodiment, as best seen in FIG. 6, the butterfly valve 60 can be displaced angularly through an obtuse angle of approximately 160° from the closed position, to an open position in which the valve closure member 62 has been angularly displaced by 90°, to an extreme “cleaning” position as shown in FIGS. 8 and 9.

As in the first embodiment, the spring-loaded pin 88 is engageable with apertures 90a, 90b in the locating flange 92, to retain the valve closure member 62 in the closed position and open position (90° to the closed position) respectively. In addition, however, a further aperture 90c is provided in the locating flange for receipt of the spring-loaded pin 88 when the valve closure member 62 is rotated to its full extent (160° to the closed position), corresponding to the cleaning position, whereby the valve closure member 62 may be retained in the cleaning position.

As best shown in FIG. 9, when in the extreme “cleaning” position, the face of the valve closure member 62 which is normally innermost is always fully accessible via the valve outlet 14 and greatly facilitates cleaning of the valve closure member 62. The improved access to the normally innermost face of the valve closure member 62 allows more thorough cleaning of the valve component, which is particularly important if the tank to which the valve is connected is to be used to transport and discharge different materials.

Otherwise, the second embodiment of valve is identical in construction and operation to the first embodiment.

The invention is not restricted to the details of the foregoing embodiments.

1. A valve assembly comprising a valve housing having an inlet, an outlet and a flow passage extending between the inlet and the outlet, and first and second valves mounted on the housing for controlling the flow of fluid through the flow passage.

2. A valve assembly as claimed in claim 1, wherein one of the first and second valves comprises a valve closure member mounted on the valve housing and releasably engageable with a valve seat, the valve seat being formed on the valve housing.

3. A valve assembly as claimed in claim 1, wherein one of the first and second valves comprises a valve closure member mounted on the valve housing and releasably engageable with a valve seat which is formed separately from the valve housing, the assembly further comprising means for attaching the valve seat to the valve housing.

4. A valve assembly comprising a valve housing having an inlet, an outlet and a flow passage extending between the inlet and the outlet, and first and second valves for controlling the flow of fluid through the flow passage, each of the first and second valves comprising a valve closure member engageable with a valve seat, the valve closure members being mounted on the valve housing.

5. A valve assembly as claimed in claim 4, wherein one of the first and second valves comprises a valve seat formed on the valve housing.

6. A valve assembly as claimed in claim 4, wherein one of the first and second valves comprises a valve seat which is formed separately from the valve housing, the assembly further comprising means for attaching the valve seat to the valve housing.

7. A valve assembly as claimed in claim 1, wherein one of the first and second valves is located adjacent to the inlet.

8. A valve assembly as claimed in claim 1, wherein one of the first and second valves is located adjacent to the outlet.

9. A valve assembly as claimed in claim 1, wherein one of the first and second valves comprises a shut-off valve.

10. A valve assembly as claimed in claim 1, wherein one of the first and second valves comprises a regulating valve.

11. A valve assembly as claimed in claim 10, wherein the regulating valve comprises a butterfly valve.

12. A valve assembly as claimed in claim 11, wherein the butterfly valve is angularly displaceable through an obtuse angle.

13. A valve assembly as claimed in claim 2, wherein the valve closure member is angularly displaceable through an angle whereby the normally innermost face of the face closure member faces downstream.

14. A valve assembly as claimed in claim 13, wherein the valve closure member is displaced through an angle of approximately 160°.

15. A valve assembly as claimed in claim 10, comprising means for temporarily securing the regulating valve in a predetermined position.

16. A valve assembly as claimed in claim 15, comprising means for temporarily securing the regulating valve in one of a plurality of predetermined positions.

17. A valve assembly as claimed in claim 1, wherein the flow passage is elongate.

18. A valve assembly as claimed in claim 17, wherein the cross-sectional area of the flow passage is larger at the outlet than at the inlet.

19. A valve assembly as claimed in claim 1, further comprising connection means for connecting the valve housing to the outlet of a source of fluid whose flow is to be controlled.

20. A valve assembly as claimed in claim 19, wherein the connection means comprises a connection flange.

21. A valve assembly as claimed in claim 1, wherein at least one of the first and second valves is operable manually.

22. A valve assembly as claimed in claim 21, wherein said at least one manually operable valve is operated by means of a handle.

23. A valve assembly as claimed in claim 21, wherein both of the first and second valves are operable manually.

24. A valve assembly as claimed in claim 23, wherein both of the first and second manually operable valves are operated by means of a handle.

25. (canceled)
